(19) United States
(12) Patent Application Publication
(10) Pub. No.: US 2026/0121048 A1
(43) Pub. Date: Apr. 30, 2026

(54) PREPARATION METHOD OF SODIUM-RICH SODIUM IRON SULFATE COMPOSITE MATERIAL AND ITS APPLICATION IN SODIUM STORAGE

(71) Applicants: Nankai University, Tianjin (CN); Tianjin Changxing New Energy Technology Co., Ltd, Tianjin (CN)

(72) Inventors: Jun CHEN, Tianjin (CN); Zhenhua YAN, Tianjin (CN); Bochao CHEN, Tianjin (CN); Jiahao WANG, Tianjin (CN); Kai ZHANG, Tianjin (CN); Haixia LI, Tianjin (CN)

(21) Appl. No.: 19/303,294

(22) Filed: Aug. 18, 2025

(30) Foreign Application Priority Data
Oct. 31, 2024 (CN) 202411536171.6

(51) Int. Cl. H01M 4/58; C01G 49/00; H01M 4/36; H01M 4/587; H01M 10/054

(52) U.S. Cl. CPC H01M 4/5825; C01G 49/009; H01M 4/366; H01M 4/587; H01M 10/054; C01P 2002/72; C01P 2002/82; C01P 2002/85; C01P 2004/03; C01P 2004/04; C01P 2006/40

(57) ABSTRACT

The present disclosure discloses a preparation method of sodium-rich sodium iron sulfate composite material and its application in sodium storage. The preparation method includes carrying out low-speed ball milling of iron-based sulfate and dispersion-treated carbon nanotubes (CNTs), performing vacuum drying and heat treatment, and naturally cooling to room temperature to obtain FeSO₄/CNTs; mixing FeSO₄/CNTs and anhydrous Na₂SO₄ according to a molar ratio of Na to Fe of 7:5.5, performing low-speed wet ball milling, vacuum drying, and grinding to obtain Na₂SO₄/FeSO₄/CNTs; compacting Na₂SO₄/FeSO₄/CNTs, loading in a tube furnace, holding at 350-400° C. for 10-24 h, cooling to room temperature, and grinding to obtain Na₇Fe_{5.5}(SO₄)₉/CNTs composite material. The inventive Na₇Fe_{5.5}(SO₄)₉ cathode material has the advantages of good specific capacity for sodium storage, excellent rate performance, and stable long cycle life.

### TECHNICAL FIELD

The present disclosure belongs to the field of sodium-ion batteries, and relates to a preparation method of sodium-rich sodium iron sulfate composite material and its application in sodium storage.

### BACKGROUND

Sodium-ion batteries are potential candidates for replacing lithium-ion batteries in large-scale energy storage applications. Polyanionic compounds are one of the four important materials (polyanionic compounds, layered oxides, Prussian blue analogs, and organic materials) used for electrochemical energy storage and conversion of sodium-ion batteries. Among the polyanionic compounds, sodium iron sulfate (NFS) has significant cost advantages, wide and green production raw material sources, rendering it an economically efficient and environmentally friendly material. When applied to the cathode of the sodium-ion battery, NFS has a working voltage as high as 3.8 V and a theoretical capacity of 120 mA·h·g⁻¹, thus possessing a significant advantage in high energy density. In addition, NFS has a stable crystal structure and strong resistance to thermal failure during charge and discharge, thus having long-cycle application potential and high safety. Meanwhile, compared with the lithium-ion battery, the sodium-ion battery has strong low-temperature fast-charging ability and small capacity degradation amplitude. Therefore, the sodium-ion batteries using NFS as the cathode materials are more suitable for replacing the lithium-ion batteries in large-scale energy storage scenarios where energy density demands are not high but with low-cost requirements, expected to completely replace lead-acid batteries in the applications of two-wheeled and three-wheeled electric vehicles, and partially replace lithium-ion batteries in four-wheeled low-speed mobility scooters and other energy storage applications.

Currently, spray drying, freeze drying, sol-gel method and one-step high-energy ball milling are the main methods for preparing the sodium iron sulfate composite material. However, spray drying method causes certain dust pollution, freeze drying method and sol-gel method are inefficient, at the same time, the above three methods require substantial water consumption, a large amount of chelating agents are used to avoid the oxidation of Fe²⁺ in NFS precursor, additionally, an extra dwell time around 200° C. is necessary during heat treatment to remove excess crystalline water, these challenges hinder the large-scale industrial production and applications of the NFS materials in the field of electrochemical energy storage. In contrast, the ball milling process has the advantages of simplicity, high efficiency and high production yield. However, one-step high-energy ball milling method imposes stringent equipment requirements, consumes substantial energy, poses safety hazards, and faces challenges in achieving material homogeneity. In addition, sodium-rich compositions can supplement a certain amount of sodium for the full battery to improve Coulombic efficiency without significantly sacrificing material cycling stability, but the NFS material family still lacks such materials with sodium-rich compositions. Consequently, developing an efficient, low-cost, high-yield, and good-homogeneity synthesis strategy of the sodium-rich sodium iron sulfate composite material remains a significant challenge.

### SUMMARY

In response to the deficiencies of the prior art and the gaps in material synthesis, the present disclosure aims to provide a preparation method of sodium iron sulfate composite material which is used for synthesizing composite material of sodium-rich sodium iron sulfate Na₇Fe_{5.5}(SO₄)₉ and carbon nanotubes (CNTs). The method has the advantages of simple process, high yield, high efficiency, strong controllability and good reproducibility. The prepared Na₇Fe_{5.5}(SO₄)₉/CNTs composite material is good in homogeneity, excellent in electrochemical property of sodium ion storage, and suitable for large-scale production and industrial applications.

The technical solutions of the present disclosure are as follows:

The first aspect of the present disclosure is to provide the preparation method of the sodium-rich sodium iron sulfate Na₇Fe_{5.5}(SO₄)₉/CNTs composite material, which uses ferrous sulfate, sodium sulfate and carbon nanotubes to prepare Na₇Fe_{5.5}(SO₄)₉/CNTs composite material via two-step low-energy solid-phase ball milling combined with pyrolysis, and the specific steps are as follows:

Step 1, loading iron-based sulfate and dispersion-treated CNTs in a ball milling jar according to a mass ratio of 6-78:0.4-6, injecting ethanol or acetone solution, carrying out low-speed ball milling under the protection of an inert atmosphere at a speed of 350-450 r/min for 12-24 h, performing vacuum drying, holding in an air-free environment at 350-400° C. for heat treatment for 8-24 h, and naturally cooling to room temperature to obtain FeSO₄/CNTs.

Step 2, mixing FeSO₄/CNTs with anhydrous Na₂SO₄ in the ball milling jar according to the molar ratio of Na to Fe of 7:5.5, performing low-speed wet ball milling at a speed of 350-450 r/min under the protection of an inert atmosphere for 12-24 h, vacuum drying in an oven at 40-80° C. for 6-12 h, and grinding to obtain black precursor powder Na₂SO₄/FeSO₄/CNTs.

Step 3, compacting the precursor powder Na₂SO₄/FeSO₄/CNTs under the pressure of 8-12 MPa, placing in a tube furnace and introducing high-purity argon or nitrogen, heating to 350-400° C. at a rate of 1-2° C./min and holding for 10-24 h, cooling to room temperature, and grinding to obtain the black powder product Na₇Fe_{5.5}(SO₄)₉/CNTs composite material.

Wherein, the mass ratio of iron-based sulfate to dispersion-treated CNTs is 6-78:0.4-6, lower CNTs content causes a decrease in the electrical conductivity of Na₇Fe_{5.5}(SO₄)₉/CNTs, resulting in poor electrochemical properties, and higher CNTs content increases the cost and causes uneven ball milling, resulting in reduced product homogeneity.

The molar ratio of Na to Fe is 7:5.5, and the composite material with this molar ratio is excellent in sodium storage electrochemical properties and can provide high capacity. The product homogeneity is high. This Na—Fe ratio has not been reported in the literature and patents, and is a material with new composition.

In the step 3, the material is held at 350-400° C. for 10-24 h. The sample synthesized below 350° C. has poor crystallinity, resulting in reduced electrical conductivity and diminished electrochemical properties. Parts of sulfates decompose at above 400° C. to generate impurity phases. Reaction times shorter than 10 hours lead to incomplete material reaction and impaired crystallinity. Reaction times longer than 24 hours increase synthesis costs and reduce synthesis efficiency.

Further, the dispersion treatment includes the steps of carrying out heat treatment of multi-walled CNTs in concentrated nitric acid solution at 60-80° C. for 12-15 h, water washing to pH 6, and vacuum drying at 60-80° C. for 12-15 h.

Further, the iron-based sulfate is ferrous sulfate heptahydrate, ferrous sulfate monohydrate or anhydrous ferrous sulfate.

Further, zirconia balls are used as the ball milling medium in both step 1 and step 2, and the ball-to-material ratio is set at 10:1-20:1.

Further, the preparation method of anhydrous Na₂SO₄ includes performing heat treatment of sodium-based sulfate with or without crystalline water in a vacuum oven at 180-220° C. for 5-8 h to remove surface-adsorbed and/or crystalline water and obtain anhydrous Na₂SO₄ without adsorbed water.

Further, the inert atmosphere in steps 1 and 2 is argon or nitrogen.

The second aspect of the present disclosure is to provide the application of the Na₇Fe_{5.5}(SO₄)₉/CNTs composite material obtained by the above preparation method as a cathode material for a sodium-ion battery. A button battery is assembled by using the Na₇Fe_{5.5}(SO₄)₉/CNTs composite material as the cathode active material, and a sodium metal sheet as the anode, wherein the cathode is prepared by mixing the Na₇Fe_{5.5}(SO₄)₉/CNTs composite material, Ketjen black and polyvinylidene fluoride (PVDF) according to a mass ratio of 8:1:1 in an appropriate amount of N-methylpyrrolidone (NMP) to form homogeneous slurry, uniformly coating on an aluminum current collector in a dry environment, and vacuum drying at 100° C. for 12 h. The electrolyte consists of 1 M sodium perchlorate (NaClO₄) dissolved in a mixture of ethylene carbonate (EC) and diethyl carbonate (DEC) at volume ratio of 1:1, with the addition of 5% volume of fluoroethylene carbonate (FEC). The test temperature is room temperature.

The beneficial effects of the present disclosure are as follows:

(1) The Na₇Fe_{5.5}(SO₄)₉/CNTs composite material prepared by the inventive method shows high crystalline phase homogeneity and uniform morphology, so that the product consistency is good. The synthesis process exhibits strong reproducibility, and the Na₇Fe_{5.5}(SO₄)₉/CNTs composite materials, obtained by varying the iron and sodium sources and using CNTs with different length-to-diameter ratios, have high purity of Na₇Fe_{5.5}(SO₄)₉, high yield and good controllability, rendering them suitable for large-scale industrial production and applications in the future.

(2) The Na₇Fe_{5.5}(SO₄)₉/CNTs composite material prepared by the inventive method features a sodium-rich composition. This design ensures structural integrity of the iron-based sulfate even when sodium loss occurs at the cathode due to sodium supply to the hard carbon anode in the full battery, thereby guaranteeing the overall charge/discharge cycling stability of the battery.

(3) The inventive Na₇Fe_{5.5}(SO₄)₉ cathode material has good specific capacity for sodium storage, excellent rate performance, and stable long cycle life. In addition, the Na₇Fe_{5.5}(SO₄)₉ cathode material has higher working voltage (3.7 V) and lower production raw material cost than layered oxide and vanadium-based polyanionic compound cathode materials, which provides significant advantages in terms of energy density, long-cycle performance and production costs.

(4) The Na₇Fe_{5.5}(SO₄)₉/CNTs composite material prepared by the inventive method has nano-sized structure, facilitating rapid ion transport, electron diffusion, and full contact between the electrodes and the electrolyte.

### BRIEF DESCRIPTION OF THE DRAWINGS

FIG. 1 shows the X-ray powder diffraction (XRD) pattern of the Na₇Fe_{5.5}(SO₄)₉/CNTs composite material prepared in Example 1.

FIG. 2 shows the XRD pattern of the Na₇Fe_{5.5}(SO₄)₉/CNTs composite material prepared in Comparative Example 1, which contains Na₃Fe(SO₄)₃ and FeSO₄ impurities.

FIG. 3 shows the Fourier transform infrared (FTIR) spectrum pattern of the Na₇Fe_{5.5}(SO₄)₉/CNTs composite material prepared in Example 1.

FIG. 4 shows the X-ray photoelectron spectroscopy (XPS) pattern of the Na₇Fe_{5.5}(SO₄)₉/CNTs composite material prepared in Example 1, wherein a) is the overall spectrum, b) is the fine spectrum of Fe, c) is the fine spectrum of S, and d) is the fine spectrum of C.

FIG. 5 shows scanning electron microscope (SEM) images of the Na₇Fe_{5.5}(SO₄)₉/CNTs composite materials prepared in Examples 1 and 5, wherein a (Example 1) and b (Example 5).

FIG. 6 shows the transmission electron microscope (TEM) image of the Na₇Fe_{5.5}(SO₄)₉/CNTs composite material prepared in Example 1.

FIG. 7 shows the galvanostatic charge-discharge (GCD) curves of the Na₇Fe_{5.5}(SO₄)₉/CNTs composite material prepared in Example 1 as the cathode of the sodium-ion battery during the first 5 cycles at a current density of 0.1 C.

FIG. 8 shows the rate performances of the Na₇Fe_{5.5}(SO₄)₉/CNTs composite material prepared in Example 1 as the cathode of the sodium-ion battery at current densities of 0.1, 0.2, 0.5, 1.0, 2.0 and 5.0 C, respectively.

FIG. 9 shows the performance of the Na₇Fe_{5.5}(SO₄)₉/CNTs composite material prepared in Example 1 as the cathode of the sodium-ion battery after 700 cycles of charge and discharge at a current density of 1 C.

FIG. 10 shows the performances of the Na₇Fe_{5.5}(SO₄)₉/CNTs composite materials prepared in Examples 1-5 and Comparative Example 1 as the cathodes of the sodium-ion batteries after 100 cycles of charge and discharge at a current density of 1 C.

### DETAILED DESCRIPTION OF THE EMBODIMENTS

The present disclosure is described in further details below through specific embodiments, which are descriptive only and not restrictive, and cannot be used to limit the scope of protection of the present disclosure.

### Example 1

The preparation method of the sodium-rich sodium iron sulfate composite material includes the following steps:

Dispersion of multi-walled carbon nanotubes (CNTs): heating 0.6 g of multi-walled CNTs in 30 mL of concentrated nitric acid solution at 70° C. for 12 h, water washing to pH 6, performing centrifuging or suction filtration, and vacuum drying at 80° C. for 12 h to obtain homogeneously dispersed CNTs.

First ball milling: mixing 6.501 g of FeSO₄·H₂O and 0.488 g of dispersed CNTs in a 70 mL ball milling jar by using ZrO₂ balls as the ball milling medium, wherein the mass of balls was set to 20 times the total material, injecting 15 mL of acetone, carrying out ball milling with argon as the protective gas at 400 r/min for 12 h, vacuum drying at 60° C. for 6 h, and collecting to obtain black powder FeSO₄·H₂O/CNTs, placing the black powder FeSO₄·H₂O/CNTs in a tube furnace with argon as carrier gas, heating to 360° C. at a rate of 2° C./min and holding for 18 h, and cooling to room temperature to obtain black powder FeSO₄/CNTs.

Second ball milling: mixing 3.874 g of the black powder FeSO₄/CNTs and 2.138 g of anhydrous Na₂SO₄ in a 70 mL ball milling jar, wherein the ball-to-material ratio was 20:1, adding 15 mL of acetone, carrying out ball milling under argon protection at 400 r/min for 12 h, vacuum drying at 60° C. for 8 h, and collecting to obtain black powder Na₂SO₄/FeSO₄/CNTs.

Compaction: manually grinding the powder Na₂SO₄/FeSO₄/CNTs, and compacting under the pressure of 10 MPa.

One-step pyrolysis: loading the compacted Na₂SO₄/FeSO₄/CNTs in a tube furnace with argon as carrier gas, heating to 400° C. at a rate of 2° C./min and holding for 12 h, cooling to room temperature, and grinding to obtain the final black powder product Na₇Fe_{5.5}(SO₄)₉/CNTs.

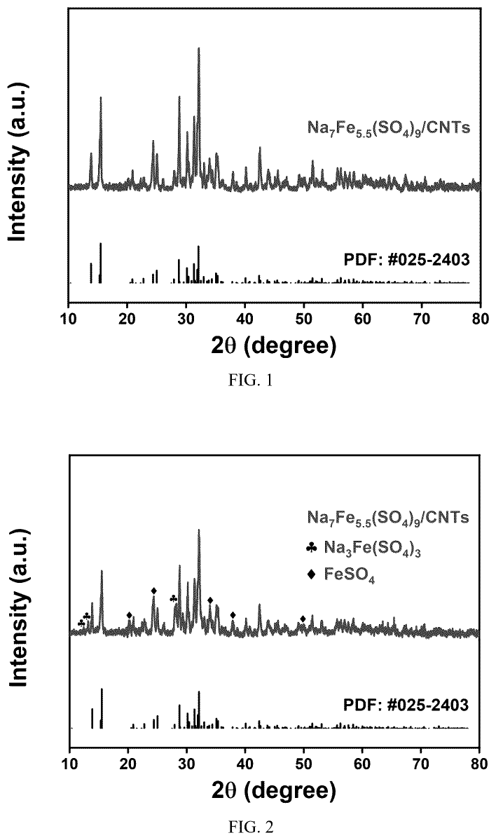

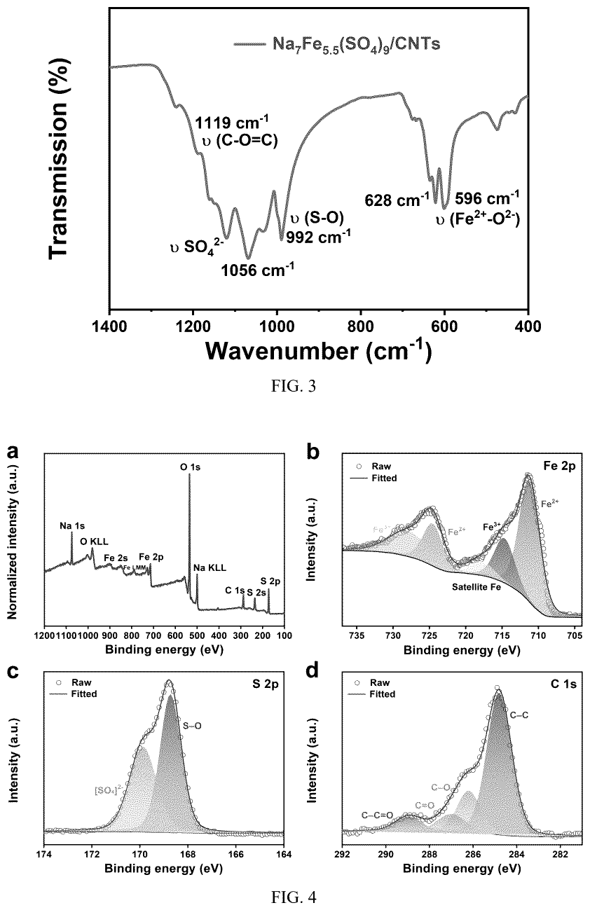

It can be seen from FIG. 1 that the Na₇Fe_{5.5}(SO₄)₉/CNTs composite material synthesized by this method is pure phase.

It can be seen from FIG. 4 that the main elemental composition of the sample includes Na, Fe, S, O and C, which is consistent with Na₇Fe_{5.5}(SO₄)₉/CNTs. A small part of Fe on the surface of Na₇Fe_{5.5}(SO₄)₉/CNTs is oxidized, but the sample still exists mainly in the form of Fe²⁺ and SO₄²⁻. The C signal exists in the form of C—C chemical bonds in large quantities, indicating the abundant presence of CNTs on the sample surface.

It can be seen from FIG. 5 that the CNTs in the Na₇Fe_{5.5}(SO₄)₉/CNTs product are uniformly dispersed, and the Na₇Fe_{5.5}(SO₄)₉ exists as nanoparticles.

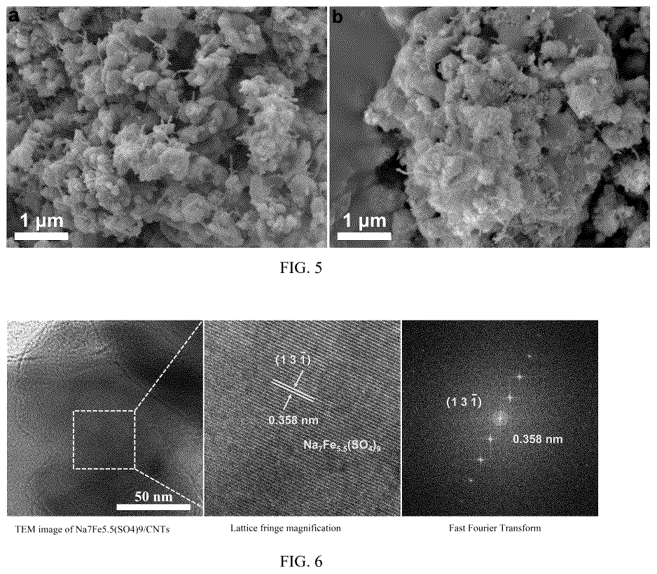

It can be seen from FIG. 6 that the Na₇Fe_{5.5}(SO₄)₉/CNTs synthesized by this method has good crystallinity and obvious lattice fringes.

### Electrochemical Property Test:

A button battery was assembled by using the Na₇Fe_{5.5}(SO₄)₉/CNTs composite material as the cathode active material, and a sodium metal sheet as the anode, wherein the cathode was prepared by mixing the Na₇Fe_{5.5}(SO₄)₉/CNTs composite material, Ketjen black and polyvinylidene fluoride (PVDF) according to a mass ratio of 8:1:1 in an appropriate amount of N-methylpyrrolidone (NMP) to form homogeneous slurry, the slurry was uniformly coated on an aluminum current collector in a dry environment, and vacuum dried at 100° C. for 12 h. The electrolyte consisted of 1 M sodium perchlorate (NaClO₄) dissolved in a mixture of ethylene carbonate (EC) and diethyl carbonate (DEC) at volume ratio of 1:1, with the addition of 5% volume of fluoroethylene carbonate (FEC). The test temperature was room temperature.

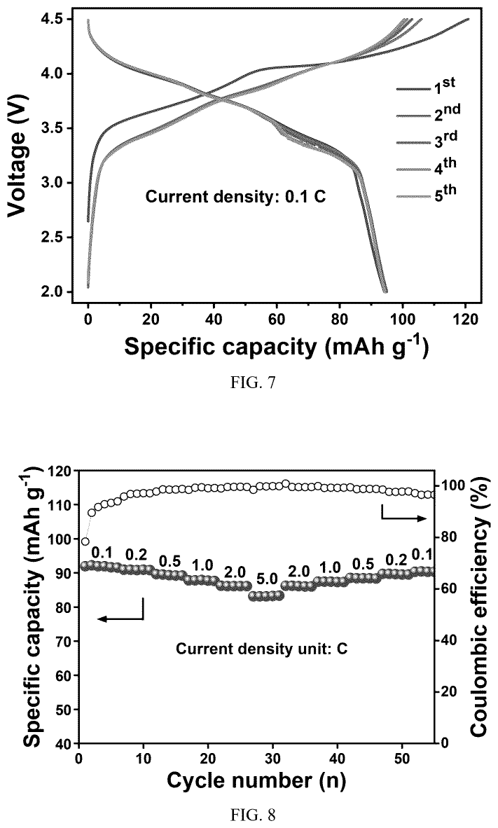

It can be seen from FIG. 7 that the Na₇Fe_{5.5}(SO₄)₉/CNTs product has an average working voltage of up to 3.7 V and good cycling stability.

It can be seen from FIG. 8 that the Na₇Fe_{5.5}(SO₄)₉/CNTs product has excellent rate performance, and still maintain a reversible specific capacity of more than 80 mA·h·g⁻¹ at a large current of 5 C.

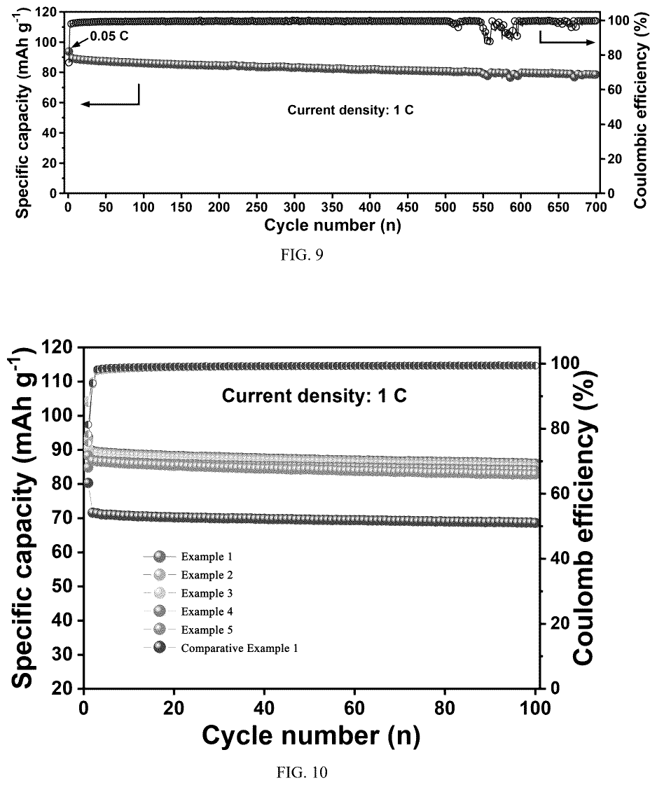

It can be seen from FIG. 9 that the Na₇Fe_{5.5}(SO₄)₉/CNTs product has excellent cycling performance, and capacity retention of 88% after 700 cycles.

### Example 2

The preparation method of the sodium-rich sodium iron sulfate composite material includes the following steps:

Dispersion of multi-walled carbon nanotubes (CNTs): heating 1.2 g of multi-walled CNTs in 50 mL of concentrated nitric acid solution at 70° C. for 12 h, water washing to pH 6, performing centrifuging or suction filtration, and vacuum drying at 80° C. for 12 h, to obtain homogeneously dispersed CNTs.

First ball milling: mixing 13 g of FeSO₄·H₂O and 0.976 g of dispersed CNTs in a 100 mL ball milling jar by using ZrO₂ balls as the ball milling medium, wherein the mass of balls was set to 12 times the total material, injecting 21 mL of acetone, carrying out ball milling with argon as the protective gas at 400 r/min for 18 h, vacuum drying at 80° C. for 6 h, and collecting to obtain black powder FeSO₄·H₂O/CNTs, placing the black powder FeSO₄·H₂O/CNTs in a tube furnace with argon as carrier gas, heating to 380° C. at a rate of 2° C./min and holding for 15 h, and cooling to room temperature to obtain black powder FeSO₄/CNTs.

Second ball milling: mixing 7.748 g of the black powder FeSO₄/CNTs and 4.276 g of anhydrous Na₂SO₄ in a 100 mL ball milling jar, wherein the ball-to-material ratio was 14:1, adding 21 mL of acetone, carrying out ball milling under argon protection at 400 r/min for 18 h, vacuum drying at 80° C. for 8 h, and collecting to obtain black powder Na₂SO₄/FeSO₄/CNTs.

Compaction: grinding the powder Na₂SO₄/FeSO₄/CNTs, and compacting under the pressure of 10 MPa.

One-step pyrolysis: loading the compacted Na₂SO₄/FeSO₄/CNTs in a tube furnace with argon as carrier gas, heating to 400° C. at a rate of 1° C./min and holding for 12 h, cooling to room temperature, and grinding to obtain the final black powder product Na₇Fe_{5.5}(SO₄)₉/CNTs.

### Example 3

The preparation method of the sodium-rich sodium iron sulfate composite material includes the following steps:

Dispersion of multi-walled carbon nanotubes (CNTs): heating 2.4 g of multi-walled CNTs in 50 mL of concentrated nitric acid solution at 70° C. for 12 h, water washing to pH 6, performing centrifuging or suction filtration, and vacuum drying at 80° C. for 12 h to obtain homogeneously dispersed CNTs.

First ball milling: mixing 50.79 g of FeSO₄·H₂O and 1.952 g of dispersed CNTs in a 200 mL ball milling jar by using ZrO₂ balls as the ball milling medium, wherein the mass of balls was set to 10 times the total material, adding 45 mL of acetone, carrying out ball milling with argon as the protective gas at 400 r/min for 24 h, vacuum drying at 40° C. for 12 h, and collecting to obtain black powder FeSO₄·H₂O/CNTs, placing the black powder FeSO₄·H₂O/CNTs in a tube furnace with argon as carrier gas, heating to 400° C. at a rate of 2° C./min and holding for 8 h, and cooling to room temperature to obtain black powder FeSO₄/CNTs.

Second ball milling: mixing 15.496 g of the black powder FeSO₄/CNTs and 8.552 g of anhydrous Na₂SO₄ in a 200 mL ball milling jar, wherein the ball-to-material ratio was 15:1, injecting 45 mL of acetone, carrying out ball milling under argon protection at 350 r/min for 24 h, vacuum drying at 60° C. for 12 h, and collecting to obtain black powder Na₂SO₄/FeSO₄/CNTs.

Compaction: grinding the powder Na₂SO₄/FeSO₄/CNTs, and compacting under the pressure of 10 MPa.

One-step pyrolysis: loading the compacted Na₂SO₄/FeSO₄/CNTs in a tube furnace with argon as carrier gas, heating to 400° C. at a rate of 2° C./min and holding for 24 h, cooling to room temperature, and grinding to obtain the final black powder product Na₇Fe_{5.5}(SO₄)₉/CNTs.

### Example 4

The preparation method of the sodium-rich sodium iron sulfate composite material includes the following steps:

Dispersion of multi-walled carbon nanotubes (CNTs): heating 4.29 g of multi-walled CNTs in 100 mL of concentrated nitric acid solution at 70° C. for 15 h, water washing to pH 6, performing centrifuging or suction filtration, and vacuum drying at 80° C. for 12 h to obtain homogeneously dispersed CNTs.

First ball milling: mixing 46.48 g of FeSO₄·H₂O and 3.49 g of dispersed CNTs in a 500 mL ball milling jar by using ZrO₂ balls as the ball milling medium, wherein the mass of balls was set to 20 times the total material, injecting 100 mL of acetone, carrying out ball milling with argon as the protective gas at 350 r/min for 24 h, vacuum drying at 80° C. for 10 h, and collecting to obtain black powder FeSO₄·H₂O/CNTs, placing the black powder FeSO₄·H₂O/CNTs in a tube furnace with argon as carrier gas, heating to 400° C. at a rate of 2° C./min and holding for 12 h, and cooling to room temperature to obtain black powder FeSO₄/CNTs.

Second ball milling: mixing 27.7 g of the black powder FeSO₄/CNTs and 15.29 g of anhydrous Na₂SO₄ in a 500 mL ball milling jar, wherein the ball-to-material ratio was 20:1, adding 100 mL of acetone, carrying out ball milling under argon protection at 400 r/min for 24 h, vacuum drying at 80° C. for 10 h, and collecting to obtain black powder Na₂SO₄/FeSO₄/CNTs.

Compaction: grinding the powder Na₂SO₄/FeSO₄/CNTs, and compacting under the pressure of 10 MPa.

One-step pyrolysis: loading the compacted Na₂SO₄/FeSO₄/CNTs in a tube furnace with argon as carrier gas, heating to 400° C. at a rate of 1.5° C./min and holding for 24 h, cooling to room temperature, and grinding to obtain the final black powder product Na₇Fe_{5.5}(SO₄)₉/CNTs.

### Example 5

The preparation method of the sodium-rich sodium iron sulfate composite material includes the following steps:

Dispersion of multi-walled carbon nanotubes (CNTs): heating 7.2 g of multi-walled CNTs in 150 mL of concentrated nitric acid solution at 70° C. for 15 h, water washing to pH 6, performing centrifuging or suction filtration, and vacuum drying at 80° C. for 15 h to obtain homogeneously dispersed CNTs.

First ball milling: mixing 78 g of FeSO₄·H₂O and 5.86 g of dispersed CNTs in a 500 mL ball milling jar by using ZrO₂ balls as the ball milling medium, wherein the mass of balls was set to 10 times the total material, adding 100 mL of acetone, carrying out ball milling with nitrogen as the protective gas at 450 r/min for 24 h, vacuum drying at 80° C. for 12 h, and collecting to obtain black powder FeSO₄·H₂O/CNTs, placing the black powder FeSO₄·H₂O/CNTs in a tube furnace with nitrogen as carrier gas, heating to 400° C. at a rate of 2° C./min and holding for 24 h, and cooling to room temperature to obtain black powder FeSO₄/CNTs.

Second ball milling: mixing 46.49 g of the black powder FeSO₄/CNTs and 25.66 g of anhydrous Na₂SO₄ in a 500 mL ball milling jar, wherein the ball-to-material ratio was 10:1, injecting 100 mL of acetone, carrying out ball milling under nitrogen protection at 450 r/min for 24 h, vacuum drying at 80° C. for 12 h, and collecting to obtain black powder Na₂SO₄/FeSO₄/CNTs.

Compaction: grinding the powder Na₂SO₄/FeSO₄/CNTs, and compacting under the pressure of 10 MPa.

One-step pyrolysis: loading the compacted Na₂SO₄/FeSO₄/CNTs in a tube furnace with nitrogen as carrier gas, heating to 400° C. at a rate of 1° C./min and holding for 24 h, cooling to room temperature, and grinding to obtain the final black powder product Na₇Fe_{5.5}(SO₄)₉/CNTs.

### Comparative Example 1

The preparation method of the sodium-rich sodium iron sulfate composite material includes the following steps:

Dispersion of multi-walled carbon nanotubes (CNTs): heating 0.6 g of multi-walled CNTs in 30 mL of concentrated nitric acid solution at 70° C. for 12 h, water washing to pH 6, performing centrifuging or suction filtration, and vacuum drying at 80° C. for 12 h to obtain homogeneously dispersed CNTs.

Performing heat treatment of 5.81 g of FeSO₄·H₂O in a vacuum drying oven at 200° C. for 12 h to remove the crystalline water.

One-step ball milling: mixing 3.574 g of FeSO₄, 2.138 g of anhydrous Na₂SO₄ and 0.3 g of dispersed CNTs in a 70 mL ball milling jar, wherein the ball-to-material ratio was 20:1, injecting 15 mL of acetone, carrying out ball milling under argon protection at 400 r/min for 12 h, vacuum drying at 60° C. for 8 h, and collecting to obtain black powder Na₂SO₄/FeSO₄/CNTs.

Compaction: manually grinding the powder Na₂SO₄/FeSO₄/CNTs, and compacting under the pressure of 10 MPa.

One-step pyrolysis: loading the compacted Na₂SO₄/FeSO₄/CNTs in a tube furnace with argon as carrier gas, heating to 400° C. at a rate of 2° C./min and holding for 12 h, cooling to room temperature, and grinding to obtain the final black powder product Na₇Fe_{5.5}(SO₄)₉/CNTs. Note that the final sample prepared by this one-step ball milling process is not pure phase and contains impurities Na₃Fe(SO₄)₃ and FeSO₄.

From FIG. 2, it can be seen that the final sample prepared by this one-step ball milling process is not pure phase, and the XRD pattern shows multiple impurity peaks.

FIG. 10 shows the performances of the Na₇Fe_{5.5}(SO₄)₉/CNTs composite materials prepared in Examples 1-5 and Comparative Example 1 as the cathodes of the sodium-ion batteries after 100 cycles of charge and discharge at a current density of 1 C. From FIG. 10, it can be seen that after continuously expanding the preparation yields of Na₇Fe_{5.5}(SO₄)₉/CNTs, the product performances remain basically consistent, and the material obtained by the two-step ball milling process is pure phase, which has better performance than that of the impure phase prepared in Comparative Example 1.

The inventive Na₇Fe_{5.5}(SO₄)₉ cathode material has good specific capacity for sodium storage, at a rate of 1 C, the specific capacity of Na₇Fe_{5.5}(SO₄)₉ in Example 1 is 89.7 mA·h·g⁻¹, Example 2 is 89.2 mA·h·g⁻¹, Example 3 is 88.1 mA·h·g⁻¹, Example 4 is 87 mA·h·g⁻¹, and Example 5 is 86.8 mA·h·g⁻¹, while that of Na₇Fe_{5.5}(SO₄)₉ in Comparative Example 1 is 71.6 mA·h·g⁻¹.

The above described are only the preferred embodiments of the present disclosure. It should be pointed out that several modifications and improvements can be made without departing from the inventive concept for ordinary technical personnel in this field, which all fall within the scope of protection of the present disclosure.

What is claimed is:

1. A preparation method of sodium-rich sodium iron sulfate composite material, comprising the following steps:
Step 1, loading iron-based sulfate and dispersion-treated carbon nanotubes (CNTs) in a ball milling jar according to a mass ratio of 6-78:0.4-6, injecting ethanol or acetone solution, carrying out low-speed ball milling under the protection of an inert atmosphere at a speed of 350-450 r/min for 12-24 h, performing vacuum drying, holding in an air-free environment at 350-400° C. for heat treatment for 8-24 h, and naturally cooling to room temperature to obtain FeSO₄/CNTs;
Step 2, mixing FeSO₄/CNTs with anhydrous Na₂SO₄ in the ball milling jar according to the molar ratio of Na to Fe of 7:5.5, performing low-speed wet ball milling at a speed of 350-450 r/min under the protection of an inert atmosphere for 12-24 h, vacuum drying in an oven at 40-80° C. for 6-12 h, and grinding to obtain black precursor powder Na₂SO₄/FeSO₄/CNTs; and
Step 3, compacting the precursor powder Na₂SO₄/FeSO₄/CNTs under the pressure of 8-12 MPa, placing in a tube furnace and introducing high-purity argon or nitrogen, heating to 350-400° C. at a rate of 1-2° C./min and holding for 10-24 h, cooling to room temperature, and grinding to obtain the black powder product Na₇Fe_{5.5}(SO₄)₉/CNTs composite material, the composite material is pure phase, CNTs are uniformly dispersed, and Na₇Fe_{5.5}(SO₄)₉ exists as nanoparticles;
wherein the dispersion treatment includes the steps of carrying out heat treatment of multi-walled CNTs in concentrated nitric acid solution at 60-80° C. for 12-15 h, water washing to pH 6, and vacuum drying at 60-80° C. for 12-15 h; and
the iron-based sulfate is ferrous sulfate heptahydrate, ferrous sulfate monohydrate or anhydrous ferrous sulfate.

2. The preparation method according to the claim 1, characterized in that zirconia balls are used as the ball milling medium in both step 1 and step 2, and the ball-to-material ratio is set at 10:1-20:1.

3. Use of the Na₇Fe_{5.5}(SO₄)₉/CNTs composite material obtained by the preparation method as claimed in claim 1 as a cathode material for a sodium-ion battery.

4. The use according to the claim 3, characterized in that the Na₇Fe_{5.5}(SO₄)₉/CNTs composite material is used as the cathode active material, a sodium metal sheet is used as an anode, and an electrolyte consists of 1 M sodium perchlorate dissolved in a mixture of ethylene carbonate and diethyl carbonate at a volume ratio of 1:1, with the addition of 5% volume of fluoroethylene carbonate.

5. Use of the Na₇Fe_{5.5}(SO₄)₉/CNTs composite material obtained by the preparation method as claimed in claim 1 as a sodium storage material.
